(19) United States
(12) Patent Application Publication
(10) Pub. No.: US 2016/0100631 A1
(43) Pub. Date: Apr. 14, 2016

(54) TEMPERATURE CONTROL OF ELECTRONIC VAPORIZERS

(71) Applicants: Michael Debono, Dallas, TX (US); Brian Chadwick, Irving, TX (US)

(72) Inventors: Michael Debono, Dallas, TX (US); Brian Chadwick, Irving, TX (US)

(21) Appl. No.: 14/881,963

(22) Filed: Oct. 13, 2015

Related U.S. Application Data
(60) Provisional application No. 62/062,861, filed on Oct. 11, 2014.

(51) Int. Cl. A24F 47/00; H05B 1/02

(52) U.S. Cl. CPC A24F 47/008; H05B 1/0244

(57) ABSTRACT

In one aspect of the disclosure, a temperature control unit (TCU) is described for use with a personal vaporizer including a tank that receives a fluid. The TCU includes an inner surface including a first metallic material, an outer surface including a second, dissimilar metallic material, and a power source in electrical communication with the inner and outer surfaces such that current is flowable from the power source to the inner and outer surfaces, whereby one of the inner and outer surfaces increases in temperature, and the other of the inner and outer surfaces decreases in temperature. In another aspect of the disclosure, a refillable tank is described for use with a personal vaporizer. The tank includes a body that is configured and dimensioned to retain a fluid, and a TCU that is connected to the body to facilitate heating and/or cooling of the body and/or the fluid.

### CROSS-REFERENCE TO RELATED APPLICATIONS

This application claims the benefit of, and priority to, U.S. Provisional Patent Application Ser. No. 62/062,861, filed on Oct. 11, 2014, the entire content of which is hereby incorporated by reference.

### TECHNICAL FIELD

The present disclosure relates generally to personal vaporizers, e.g., electronic cigarettes, and more specifically, to devices, systems, and methods for controlling the temperature and pressure of personal vaporizers.

### BACKGROUND

Personal vaporizers have become a popular alternative to conventional cigarettes. A typical personal vaporizer, identified by the reference character 100 in FIG. 1, includes a battery 1, a power button 2, a refillable tank 3 that is configured and dimensioned to receive a fluid, a wick 4 that is at least partially positioned within the tank 3, a mouthpiece 5, toggles (switches) 6 to control operation of the vaporizer 100, a display 7, e.g., an LED display, a microchip 8, and an atomizer 9. In general, the tank 3 is formed from any material suitable for retaining the fluid such as, for example, plastic, glass, Pyrex, ceramic, or metallic materials.

Often times one or more components of the vaporizer 100 will be separable or disassemblable from the remainder of the unit to permit cleaning, maintenance or repair, replacement, exchange, etc. For example, the battery 1 is often removable in order to permit recharging or replacement, and the tank 3 may also be removable in order to permit the user to refill the tank with additional fluid, or replace the tank altogether.

Known vaporizers, however, have several drawbacks. For example, variations in temperature and/or pressure can result in the leakage of fluid from the vaporizer, as well as changes in the viscosity of the fluid, which may negatively impact the efficiency, efficacy, and/or overall use of the vaporizer. Additionally, with respect to electronic cigarettes in particular, it has been found that variations in temperature and/or pressure can also impact the characteristics of the vapor formed by the electronic cigarettes, e.g., the taste of the vapor.

The present disclosure addresses these concerns by providing various devices, systems, and methods for controlling the temperature and pressure in personal vaporizers.

### SUMMARY

In accordance with one aspect of the present disclosure, a temperature control unit is disclosed for use with a personal vaporizer including a tank that is configured and dimensioned to retain a fluid. The temperature control unit includes an inner surface including a first metallic material, an outer surface including a second, dissimilar metallic material, and a power source in electrical communication with the inner and outer surfaces such that current is flowable from the power source to the inner and outer surfaces, whereby one of the inner and outer surfaces experiences an increase in temperature, and the other of the inner and outer surfaces experiences a decrease in temperature.

In certain embodiments, the temperature control unit may further include a first thermocouple connected to the inner surface to measure the temperature of the inner surface, and a second thermocouple connected to the outer surface to measure the temperature of the outer surface.

In certain embodiments, the temperature control unit may further include a controller in electrical communication with the first and second thermocouples such that temperature data collected by the first and second thermocouples is communicated to the controller.

In certain embodiments, the controller may be in electrical communication with the power source such that the flow of current from the power source to the inner surface and the outer surface can be interrupted by the controller.

In certain embodiments, the controller may be programmable to interrupt the flow of current from the power source to the inner surface and the outer surface upon the measurement of a predetermined temperature by one or more of the first and second thermocouples.

In certain embodiments, the temperature control unit may further include a toggle in communication with the power source to initiate and suspend the flow of current from the power source to the first surface and the second surface.

In certain embodiments, the temperature control unit may further include at least one toggle in communication with the power source to vary current flow from the power source to the first surface and the second surface to thereby control the temperature of the first and second surfaces.

The inner surface of the temperature control unit defines a first surface area, and the outer surface defines a second surface area. In certain embodiments, the first surface area and the second surface area may approximately equal. Alternatively, the first surface area and the second surface area may be unequal.

In another aspect of the present disclosure, a refillable tank is disclosed for use with a personal vaporizer. The tank includes a body that is configured and dimensioned to retain a fluid therein, and a temperature control unit that is connected to the body of the tank to facilitate heating and/or cooling of the body of the tank and/or the fluid retained therein.

In certain embodiments, the temperature control unit may comprise an inner surface including a first metallic material, and an outer surface including a second, dissimilar metallic material.

In certain embodiments, the refillable tank may further include a first thermocouple connected to the inner surface to measure the temperature of the inner surface, and a second thermocouple connected to the outer surface to measure the temperature of the outer surface.

In certain embodiments, the refillable tank may further include a controller in electrical communication with the first and second thermocouples such that temperature data collected by the first and second thermocouples is communicated to the controller.

In certain embodiments, the refillable tank may further include a power source in electrical communication with the inner and outer surfaces of the temperature control unit such that current is flowable from the power source to the inner and outer surfaces, whereby one of the inner and outer surfaces experiences an increase in temperature, and the other of the inner and outer surfaces experiences a decrease in temperature.

In certain embodiments, the power source may be integral to the temperature control unit.

In certain embodiments, the controller may be in electrical communication with the power source such that the flow of current from the power source to the inner surface and the outer surface can be interrupted by the controller.

In certain embodiments, the controller may be programmable to interrupt the flow of current from the power source to the inner surface and the outer surface upon the measurement of a predetermined temperature by one or more of the first and second thermocouples.

The inner surface of the temperature control unit defines a first surface area, and the outer surface defines a second surface area. In certain embodiments of the refillable tank, the first surface area and the second surface area may be approximately equal. Alternatively, the first surface area and the second surface area may be unequal.

### BRIEF DESCRIPTION OF THE FIGURES

Various embodiments of the present disclosure are described herein with reference to the figures, wherein:

FIG. 1 is a side view of an exemplary prior art personal vaporizer;

FIG. 2 is a side view illustrating the personal vaporizer shown in FIG. 1 in conjunction with one embodiment of a temperature control unit (TCU) according to the principles of the present disclosure;

FIG. 3 is an enlarged view of the TCU shown in FIG. 2;

FIG. 4 is a longitudinal cross-sectional view of a tank for use with a personal vaporizer that includes the TCU shown in FIGS. 2 and 3;

FIG. 5 is a transverse cross-sectional view of an alternate embodiment of the tank and the TCU shown in FIG. 4 and

FIG. 6 is a side view of a personal vaporizer according to the principles of the present disclosure including an integral TCU.

### DETAILED DESCRIPTION

Various embodiments of the present disclosure will now be described in detail with reference to the figures, wherein like references numerals identify similar or identical elements. In the figures, and in the following description, the term “personal vaporizer” should be understood to encompass electronic cigarettes, nicotine delivery systems, and the like.

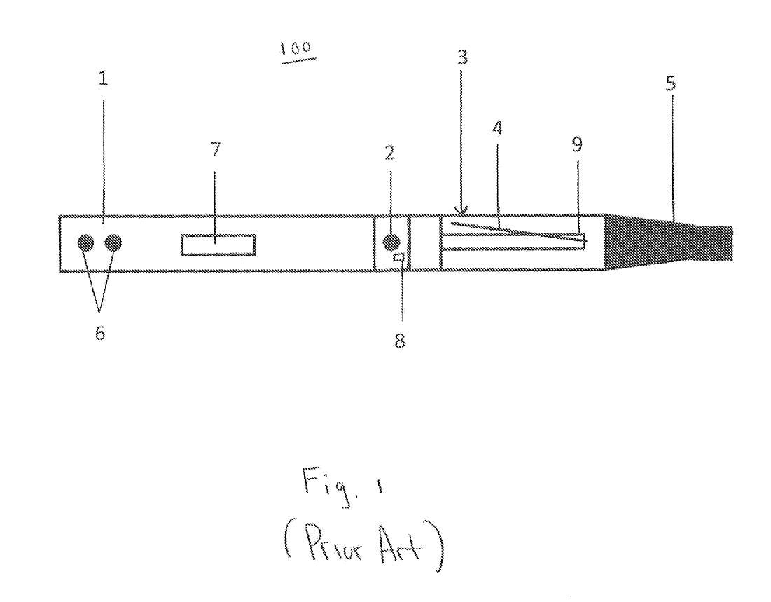

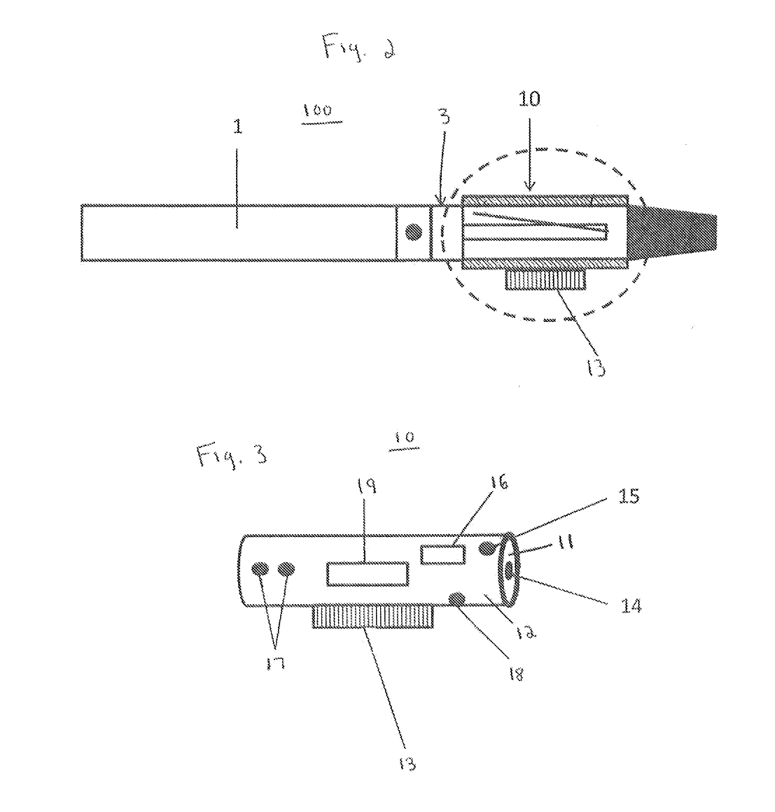

FIG. 2 illustrates one embodiment of a temperature control unit (TCU) 10, shown in conjunction with the vaporizer 100 (FIG. 1), which is configured, dimensioned, and adapted to provide the user with a measure of control over the temperature of the vaporizer 100 e.g., the tank 3 and/or the fluid within the tank 3. In the specific embodiment illustrated embodiment in FIG. 2, the TCU 10 is configured and dimensioned for positioning about the tank 3. To facilitate positioning about the tank 3, it is envisioned that the TCU 10 may include one or more expandable/contractible portions, e.g., one or more elastic, stretchable, or otherwise deflectable members. Additionally, or alternatively, the TCU 10 may include an over clamp design such that the TCU 10 may be “opened” for positioning about the tank 3, and thereafter “closed” and locked in place in secured contact with the tank 3. It is further envisioned that the TCU 10 may be configured and dimensioned in correspondence with a particular tank design, e.g., a tank 3 that is manufactured or distributed by a particular commercial source, such that the TCU 10 defines an inner contour corresponding to an outer contour defined by the tank 3 such that the TCU 10 receives the tank 3 in mating engagement.

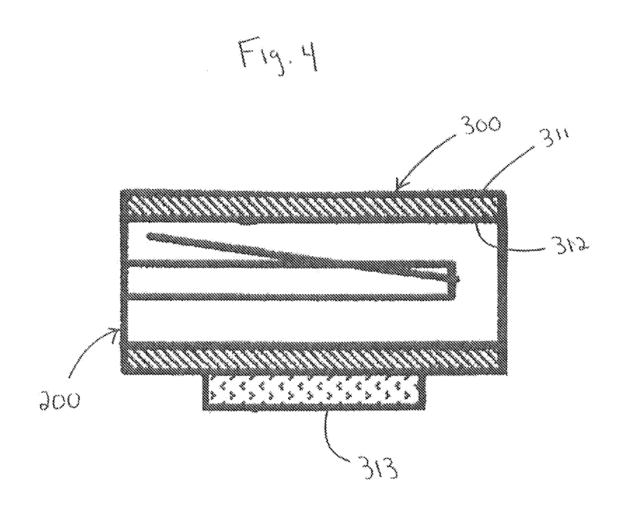

As seen in FIGS. 2 and 3, the TCU 10 includes an inner surface 11, an opposing outer surface 12, an integral, dedicated power source 13, e.g., a battery, in electrical communication with the respective inner and outer surfaces 11, 12, thermocouples 14, 15, a controller 16, e.g., a microchip including a processor, one or more toggles 17, e.g., a power switch/button 18, and a display 19, e.g., an LED display.

The inner surface 11 of the TCU 10 includes, e.g., is at least partially formed from, a first metallic material, such as copper, and is positioned in contact with the tank 3, e.g. an external surface of the tank 3. The outer surface 12 of the TCU 10 includes, e.g., is at least partially formed from, a second, dissimilar metallic material, such as a copper-nickel alloy. To facilitate temperature regulation of the tank 3, the TCU 10 utilizes the thermoelectric effect, also sometimes known as the Peltier effect, wherein the dissimilar metals of the respective inner and outer surfaces 11, 12 are subjected to a controlled flow of current from the power source 13 such that one of the inner and outer surfaces 11, 12 experiences an increase in temperature, and the other of the inner and outer surfaces experiences a decrease in temperature.

In one embodiment, the outer surface 12 of the TCU includes, e.g., is at least partially formed from, copper, and the inner surface includes, e.g., is at least partially formed from, copper-nickel alloy. In alternate embodiments, however, the respective inner and outer surfaces 11, 12 may include, e.g., may be at least partially formed from, any dissimilar materials capable of achieving the desired thermoelectric effect upon the flow of current to the surfaces 11, 12. It is also envisioned that the respective inner and outer surfaces 11, 12 may include combinations of materials to achieve a particular effect, e.g., a particular range of available temperature options. Dependent upon the desired rate of heating and cooling, and/or the desired temperature range, it may be desirable to vary the materials respectively included in the inner and outer surfaces 11, 12, or to utilize certain materials either exclusively, or in combination with each other.

The TCU 10 may be configured and oriented to either heat or cool the tank 3 and/or the fluid within the tank 3 via contact with the inner surface 11 of the TCU 10. To achieve the opposite effect, i.e., to change from a “cooling” mode to a “heating” mode, the flow of current to the respective inner and outer surfaces 11, 12 can simply be reversed, e.g., via manipulation of one of the toggles 17 or the power switch/button 18.

The rate at which the tank 3 may be cooled and heated, and the extent to which the tank 3 may be cooled and heated, may be adjusted by increasing or decreasing the surface area of the material in contact with the tank 3, and/or by varying the first and second metallic materials respectively included in the inner and outer surfaces 11, 12. Specifically, increasing the surface area of the material in contact with the tank 3 will increase not only the rate at which the tank 3 may be cooled and heated, but the achievable range of temperatures, while decreasing the surface area of the material in contact with the tank 3 will reduce the rate at which the tank 3 may be cooled and heated, as well as the achievable range of temperatures. Dependent upon the particular materials used in fabrication of the TCU 10, it is envisioned that the surface areas of the respective inner and outer surfaces 11, 12 may be approximately equal to each other, e.g., ±10%, that the surface area of the inner surface 11 may exceed the surface area of the outer surface 12, or that the surface area of the outer surface 12 may exceed the surface area of the inner surface 11.

It is further envisioned that the TCU 10 may include one or more resistors, or other such control means, to facilitate control of the current from the power source 13. By varying the amount of current flowing to the TCU 10 from the power source 13, the cooling and heating effect of the TCU 10 can thus be regulated to permit more precise control over the temperature of the tank 3 and/or the fluid retained therein.

In operation, as discussed above, the TCU 10 may be utilized to adjust the temperature of the tank 3 and/or the fluid retained within the tank 3. For example, when the vaporizer 100 is exposed to higher ambient temperatures, e.g., above 80° F., the TCU 10 can be utilized to cool the tank 3 in order to inhibit the leakage of fluid that may otherwise occur. Additionally, or alternatively, the TCU 10 can be utilized to maintain the fluid within the tank 3 at a particular desired temperature. For example, fluids with certain flavor profiles may be more enjoyable at certain temperatures, which may be either higher or lower than room temperature, or the temperature of the ambient. It is also envisioned that the tank 3 may be filled with fluids having flavor profiles that vary with temperature. For example, certain fluids may have a particular flavor profile at one temperature, and another flavor profile at another temperature. To facilitate such changes in temperature of the fluid, the flow of current may be varied to alternate between “cooling” and “heating” modes, and/or the resistor may be actuated to increase or decrease the flow of current to the TCU 10, e.g., via the toggles 17.

By varying the temperature of the fluid housed within the tank 3, the viscosity of the fluid may also be influenced. For example, it has been found that the flow of fluid through the tank 3 to the atomizer 9 may be inhibited at colder temperatures. In such instances, the TCU 10 may be utilized to heat the tank 3, and thus the fluid, such that the flow of fluid is normalized.

With continued reference to FIGS. 2 and 3, the controller 16 and the thermocouples 14, 15 will be discussed. The thermocouples 14, 15 are positioned in electrical communication with the controller 16 such that temperature data collected by the thermocouples 14, 15 is delivered to the controller 16, which is in turn in electrical communication with the power source 13. The thermocouple 15 is configured, dimensioned, and adapted to collect data regarding the temperature of the tank 3, e.g., the temperature of an outer surface of the tank 3, which will typically correspond to the temperature of the fluid housed within the tank 3, and the thermocouple 14 is configured, dimensioned, and adapted to collect data regarding the temperature of the outer surface 12 of the TCU 10. It is envisioned that the controller 16 may be programmed to intermittently interrupt the flow of current to the TCU 10 via communication with the power source 13 when the temperature measured by one or more of the thermocouples 14, 15 reaches a predetermined threshold, e.g., to prevent overheating, or to maintain the temperature at the predetermined threshold value.

While in the specific design illustrated in FIGS. 2 and 3, the thermocouple 15 is shown in contact with the outer surface 12 of the tank 3 and the thermocouple 14 is shown embedded in the outer surface 12 of the TCU, the thermocouples 14, 15 and the controller 16 may be positioned in any location suitable for the intended purpose of collecting and processing temperature information communicated from the respective first and second surfaces 11, 12. As such, the locations of the thermocouples 14, 15 and/or the controller 16 may be varied without departing from the scope of the present disclosure.

In certain embodiments, it is envisioned that a desired temperature, or other such data, may be input into the controller 16, thereby providing the user with the ability to customize the temperature at which the vaporizer 100 operates independently of the ambient temperature. For example, the user may employ the toggles 17 to input a desired temperature, or temperature condition such as “cold,” “cool,” “warm,” or “hot,” which can be read from the display 19. Additional options and measurements may include a power level setting for the vaporizer 100 and the atomizer 9, a voltage setting for operation of the vaporizer 100 and the atomizer 9, remaining vapes, e.g., based upon the available amount of power in the power source 13, and color choices for the display 19.

To further regulate heat dissipation of the TCU 10, in one embodiment, it is envisioned that the TCU 10 may include a heat sink.

When operating to cool the tank 3, current will be delivered from the power source 13 to the TCU 10 such that the temperature of the outer surface 12 of the TCU 10 increases, and the temperature of the inner surface 11 of the TCU 10 decreases. To inhibit any undesired contact between the user and the outer surface 12 of the TCU 10, the TCU 10 may further include a sleeve, cover, insulative member, etc., positioned about the outer surface 12 of the TCU 10.

During operation of the TCU 10, it is envisioned that the display 19 may provide the user with various types of information concerning operation of the vaporizer 100 including, but not limited to, temperature information, e.g., the temperature of the tank 3 and/or the temperature of the outer surface 12 of the TCU 10, power remaining in the power source 13, etc.

In various embodiments of the disclosure, it is envisioned that certain components and features of the TCU 10 may be eliminated, such as the toggles 17, the display 19, the thermocouples 14, 15, etc., e.g., to eliminate costs. In such embodiments, however, the general principles of operation of the TCU 10 would remain otherwise unchanged.

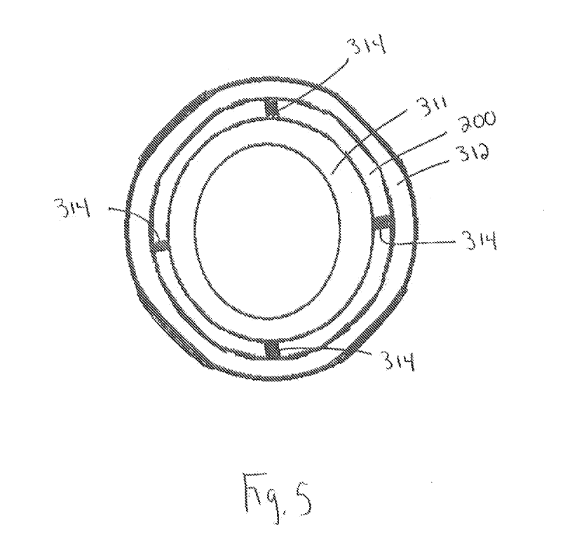

While the TCU 10 discussed above has been described as a standalone device that may be used in conjunction with the vaporizer 100 (FIG. 1), in an alternate aspect of the disclosure, seen in FIG. 4, a tank 200 is disclosed that includes an integral TCU, which is identified by the reference character 300. The tank 200 and the TCU 300 are identical to the tank 3 and the TCU 10 discussed above but for the integration of the two components, and any distinctions discussed below.

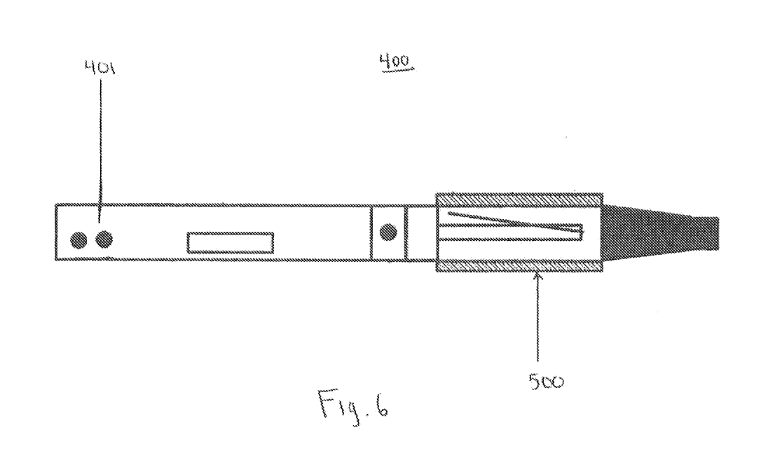

The tank 200 and the TCU 300 are integrally connected, e.g., via a suitable adhesive or a pressure-fit arrangement, or via formation from a common material, e.g., such that the tank 200 and the TCU 300 share a common wall. In one embodiment, illustrated in FIG. 4, it is envisioned that the TCU 300 may be configured and dimensioned such that the respective inner and outer surfaces 311, 312 are each located externally of the tank 200. Specifically, the TCU 300 may be oriented such that the inner surface 311 is in contact with an outer surface of the tank 200. Alternatively, the TCU 300 may be configured and dimensioned such that the inner surface 311 is located within the tank 200, and the outer surface 312 is located externally of the tank 200, as illustrated in FIG. 5. In such embodiments, the respective inner and outer surfaces 311, 312 may be connected by one or more bridge members 314 that extend between the surfaces 311, 312.

With momentary reference to FIG. 1, it is not uncommon for the various components of the vaporizer 100 to be provided separately in the marketplace. For example, once a vaporizer 100 has initially been purchased, a user may elect to purchase an additional battery 1, tanks 3, and/or mouthpieces 5, or to refill the tank 3 with different varieties of fluid. In such instances, rather than purchasing the tank 3, the user may opt for the tank 200, and thus, the TCU 300, illustrated in FIG. 4 to provide for an increased measure of control over operation of the vaporizer 100. The tank 200 may simply be exchanged for the tank 3, and connected to the remaining portion of the vaporizer 100.

It is envisioned that the TCU 300 may include a separate power source 313, as discussed above in connection with the power source 13 illustrated in FIGS. 2 and 3. Alternatively, it is envisioned that the tank 200 may be placed into electrical communication with the power source of the vaporizer 100, i.e., the battery 1 illustrated in FIG. 1, upon connection to the vaporizer 100, as is common in the art with respect to other electrical parts of a vaporizer.

With reference now to FIG. 6, a personal vaporizer is illustrated, identified generally by the reference character 400, that includes an integral TCU 500. The personal vaporizer 400 and the TCU 500 are identical to the personal vaporizer 100 and the TCU 10 discussed above but for the integration of the TCU 500, and the distinctions highlighted below.

As discussed above in connection with FIG. 5, it is envisioned that the TCU 500 may include a separate power source. Alternatively, the TCU 500 may be in direct electrical communication with the power source of the vaporizer 400, i.e., the battery 401, thereby obviating the need for an additional power source.

Persons skilled in the art will understand that the various exemplary aspects of the present disclosure described herein, and shown in the accompanying figures, constitute non-limiting examples of the present disclosure, and that additional components and features may be added to any of the embodiments discussed herein above without departing from the scope of the present disclosure.

Additionally, persons skilled in the art will understand that the elements and features shown or described in connection with one example of the present disclosure may be combined with those of another without departing from the scope of the present disclosure, and will appreciate further features and advantages of the presently disclosed subject matter based on the description provided.

What is claimed is:

1. A temperature control unit for use with a personal vaporizer including a tank configured and dimensioned to retain a fluid, the temperature control unit comprising:
an inner surface including a first metallic material;
an outer surface including a second, dissimilar metallic material; and
a power source in electrical communication with the inner and outer surfaces such that current is flowable from the power source to the inner and outer surfaces, whereby one of the inner and outer surfaces experiences an increase in temperature, and the other of the inner and outer surfaces experiences a decrease in temperature.

2. The temperature control unit of claim 1 further including a first thermocouple connected to the inner surface to measure the temperature of the inner surface, and a second thermocouple connected to the outer surface to measure the temperature of the outer surface.

3. The temperature control unit of claim 2 further including a controller in electrical communication with the first and second thermocouples such that temperature data collected by the first and second thermocouples is communicated to the controller.

4. The temperature control unit of claim 3, wherein the controller is in electrical communication with the power source such that the flow of current from the power source to the inner surface and the outer surface can be interrupted by the controller.

5. The temperature control unit of claim 4, wherein the controller is programmable to interrupt the flow of current from the power source to the inner surface and the outer surface upon the measurement of a predetermined temperature by one or more of the first and second thermocouples.

6. The temperature control unit of claim 1 further including a toggle in communication with the power source to initiate and suspend the flow of current from the power source to the inner surface and the outer surface.

7. The temperature control unit of claim 1 further including at least one toggle in communication with the power source to vary current flow from the power source to the inner surface and the outer surface to thereby control the temperature of the first and second surfaces.

8. The temperature control unit of claim 1, wherein the inner surface defines a first surface area and the outer surface defines a second surface area.

9. The temperature control unit of claim 8, wherein the first and second surface areas are approximately equal.

10. The temperature control unit of claim 8, wherein the first surface area and the second surface area are unequal.

11. A refillable tank for use with a personal vaporizer, the tank comprising:
a body configured and dimensioned to retain a fluid therein; and
a temperature control unit connected to the body of the tank to facilitate heating and/or cooling of the body of the tank and/or the fluid retained therein.

12. The refillable tank of claim 11, wherein the temperature control unit comprises an inner surface including a first metallic material, and an outer surface including a second, dissimilar metallic material.

13. The refillable tank of claim 12 further including a first thermocouple connected to the inner surface to measure the temperature of the inner surface, and a second thermocouple connected to the outer surface to measure the temperature of the outer surface.

14. The refillable tank of claim 13 further including a controller in electrical communication with the first and second thermocouples such that temperature data collected by the first and second thermocouples is communicated to the controller.

15. The refillable tank of claim 14 further including a power source in electrical communication with the inner and outer surfaces of the temperature control unit such that current is flowable from the power source to the inner and outer surfaces, whereby one of the inner and outer surfaces experiences an increase in temperature, and the other of the inner and outer surfaces experiences a decrease in temperature.

16. The refillable tank of claim 15, wherein the power source is integral to the temperature control unit.

17. The refillable tank of claim 15, wherein the controller is in electrical communication with the power source such that the flow of current from the power source to the inner surface and the outer surface can be interrupted by the controller.

18. The refillable tank of claim 17, wherein the controller is programmable to interrupt the flow of current from the power source to the inner surface and the outer surface upon the measurement of a predetermined temperature by one or more of the first and second thermocouples.

19. The refillable tank of claim 11, wherein the inner surface defines a first surface area and the outer surface defines a second surface area, the first and second surface areas being approximately equal.

20. The refillable tank of claim 11, wherein the inner surface defines a first surface area and the outer surface defines a second surface area, the first and second surface areas being unequal.
